(19) United States
(12) Patent Application Publication
(10) Pub. No.: US 2009/0016305 A1
(43) Pub. Date: Jan. 15, 2009

(54) METHOD FOR AVOIDING AND OVERCOMING INDIRECT COLLISION IN BEACON-MODE WIRELESS SENSOR NETWORK

(75) Inventors: Jongyoung LEE, Daejon (KR); Sun-Joong KIM, Daejon (KR); Cheol-Sig PYO, Daejon (KR); Jong-Suk CHAE, Daejon (KR)

Correspondence Address: CANTOR COLBURN, LLP, 20 Church Street, 22nd Floor, Hartford, CT, 06103, US

(73) Assignee: Electronics and Telecommunications Research Institute, Daejon (KR)

(21) Appl. No.: 12/169,375

(22) Filed: Jul. 8, 2008

(30) Foreign Application Priority Data
Jul. 9, 2007 (KR) 10-2007-0068694

(51) Int. Cl. H04J 3/00; H04L 12/43; H04Q 7/24

(52) U.S. Cl. 370/336; 370/461; 370/338

(57) ABSTRACT

There is provided to a method for avoiding indirect collision of beacon, including: collecting beacon information of neighboring nodes and allocating a time slot based on the collected beacon information; transmitting information on the allocated time slot to the neighboring nodes depending on time slots of the neighboring nodes; and checking whether the time slot overlaps based on a reply message from the neighboring nodes and reallocating a time slot upon occurrence of overlapping.

### CROSS-REFERENCE TO RELATED APPLICATIONS

The present invention claims priority of Korean Patent Application No. 10-2007-0068694, filed on Jul. 9, 2007, which is incorporated herein by reference.

This work was supported by the IT R&D program of MIC/ITTA [2005-S-038-02, “Development of UHF RF-ID and Ubiquitous Networking Technology”].

### BACKGROUND OF THE INVENTION

1. Field of the Invention

The present invention relates to a method for avoiding and overcoming indirect collision in a beacon-mode wireless sensor network; and, more particularly, to a method for avoiding and overcoming indirect collision of nodes in a beacon-mode wireless sensor network, which allows a specific node to collect beacon information of its neighboring nodes and to allocate its own time slot based on the collected beacon information to prevent indirect collision, and to request the deepest node among nodes having indirect collision occurred to change the time slot, upon occurrence of beacon collision, to overcome the indirect collision.

In the following embodiments of the present invention, it should be noted that an ad-hoc network will be described as an example of a wireless sensor network, but the present invention is not limited to this.

The present invention is derived from the study that has been made as a part of the development business for IT new growth engine core technology (Project No. 2005-S-038-02, and Project Name: UHF RF-ID and Ubiquitous Networking Technology).

2. Description of Related Art

According to a Zigbee network topology, the respective nodes in a network system are divided into a Zigbee Coordinator (ZC), a Zigbee Router (ZR), and a Zigbee End Device (ZE).

Among these, the ZC is located at the uppermost end in a tree structure and manages the entire tree, and the ZR generates its own beacon signal at the time it does not collide with a ZC's beacon signal for communication with lower nodes.

Meanwhile, the ZE is located at the lowermost end in the network topology and performs required data communication by using a beacon signal transmitted from the ZR or ZC.

For formation of this tree structure, the ZR or ZC transmits the beacon signal for communication with other lower nodes. At this time, when two or more Full Function Devices (FFDs) do not detect signals therebetween but transmit a beacon signal by using the same time slot, neighboring nodes that exist in overlapping transmission areas do not receive the beacon signal from the FFDs.

Further, the wireless sensor network is comprised of a self-organized network, and therefore, nodes on the network also have mobility. Due to this mobility of nodes, however, the network cannot know geographical distribution of nodes and cannot also set links or channels for the nodes in advance. In addition, this may cause indirect collision between nodes when the nodes perform data communication over the network.

FIG. 1 is an explanatory view showing an example of indirect collision of beacon in a conventional beacon-mode ad-hoc network.

As shown in FIG. 1, in case where a node N1 101 is connected to a node FFD1 102, when a new node FFD2 103 generates a beacon signal by using the same time slot as the FFD1 in the same way each time the node FFD1 102 generates a beacon signal, beacon collision may occur because the node N1 101 simultaneously receives the beacon signal from the nodes FFD1 102 and FFD2 103.

FIG. 2 is an explanatory view showing an example of a beacon transmission time in a conventional beacon-mode ad-hoc network.

As illustrated in FIG. 2, a beacon transmission period of the node FFD1 102 is almost identical to that of the node FFD2 103. This means that the nodes FFD1 102 and FFD2 103 transmit the beacon signal at an almost identical time.

In the above prior art, when indirect collision happens in a beacon-mode ad-hoc network due to the identical beacon transmission period between the nodes, nodes (ZCs or ZRs that have to receive the beacon signals) connected to the nodes having the indirect collision occurred do not normally receive the beacon signal.

In this case, since beacon collision continuously occurs unless information on the occurrence of indirect collision is provided to the nodes transmitting the beacon signal, the ZCs or ZRs that need to receive the beacon signals cannot continuously receive the beacon signal.

Hitherto, however, no scheme has been proposed to solve such indirect collision problem in the beacon-mode ad-hoc network.

Consequently, there is an urgent need for a scheme which prevents indirect collision in the beacon-mode ad-hoc network and overcomes the indirect collision upon occurrence thereof.

### SUMMARY OF THE INVENTION

It is, therefore, an object of the present invention to a method for avoiding and overcoming indirect collision of nodes in a beacon-mode wireless sensor network, which allows a specific node to collect beacon information of its neighboring nodes and to allocate its own time slot based on the collected beacon information to prevent indirect collision, and to request the deepest node among nodes having indirect collision occurred to change the time slot, upon occurrence of beacon collision, to overcome the indirect collision.

In accordance with one aspect of the present invention, there is provided to a method for avoiding indirect collision of beacon, including: collecting beacon information of neighboring nodes and allocating a time slot based on the collected beacon information; transmitting information on the allocated time slot to the neighboring nodes depending on time slots of the neighboring nodes; and checking whether the time slot overlaps based on a reply message from the neighboring nodes and reallocating a time slot upon occurrence of overlapping.

In accordance with another aspect of the present invention, there is provided to a method for overcoming beacon collision, including: upon prediction of indirect collision occurrence at neighboring nodes, transmitting an indirect collision possibility message to the neighboring nodes and receiving a reply message from the neighboring nodes; upon presence of overlapping time slot based on the received replay message, requesting neighboring nodes which use the overlapping time slot to send node information and receiving the node information; and requesting for the time slot change based on the received node information.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### BRIEF DESCRIPTION OF THE DRAWINGS

FIG. 1 is an explanatory view showing an example of indirect collision of beacon in a conventional beacon-mode ad-hoc network.

FIG. 2 is an explanatory view showing an example of a beacon transmission time in a conventional beacon-mode ad-hoc network.

FIG. 3 is an explanatory view illustrating a beacon information collection procedure of avoiding indirect collision of beacon in a beacon-mode ad-hoc network in accordance with the present invention.

FIG. 4 illustrates time slot information tables for beacon information management of neighboring nodes used in the present invention.

FIG. 5 is a flowchart illustrating a method for avoiding indirect collision of beacon by a node that newly allocates a time slot in a beacon-mode ad-hoc network in accordance with a preferred embodiment of the present invention.

FIG. 6 is a view describing the time the node that newly allocates a time slot collects time slot information transmitted from neighboring nodes in a beacon-mode ad-hoc network in accordance with the present invention.

FIG. 7 is a flowchart describing a method for checking whether time slots of neighboring nodes receiving a time slot allocation message overlap in a beacon-mode ad-hoc network in accordance with the present invention.

FIG. 8 is a flowchart describing a method for requesting change of collided time slots of nodes when indirect collision of beacon takes place in a beacon-mode ad-hoc network in accordance with the present invention.

FIG. 9 is a view describing an overhead with respect to the depth of each node in a beacon-mode ad-hoc network in accordance with the present invention.

### DESCRIPTION OF SPECIFIC EMBODIMENTS

The advantages, features and aspects of the invention will become apparent from the following description of the embodiments with reference to the accompanying drawings, which is set forth hereinafter, and thus, the present invention will easily be carried out by those skilled in the art. Further, in the following description, well-known arts will not be described in detail if it seems that they could obscure the invention in unnecessary detail. Hereinafter, a preferred embodiment of the present invention will be set forth in detail with reference to the accompanying drawings.

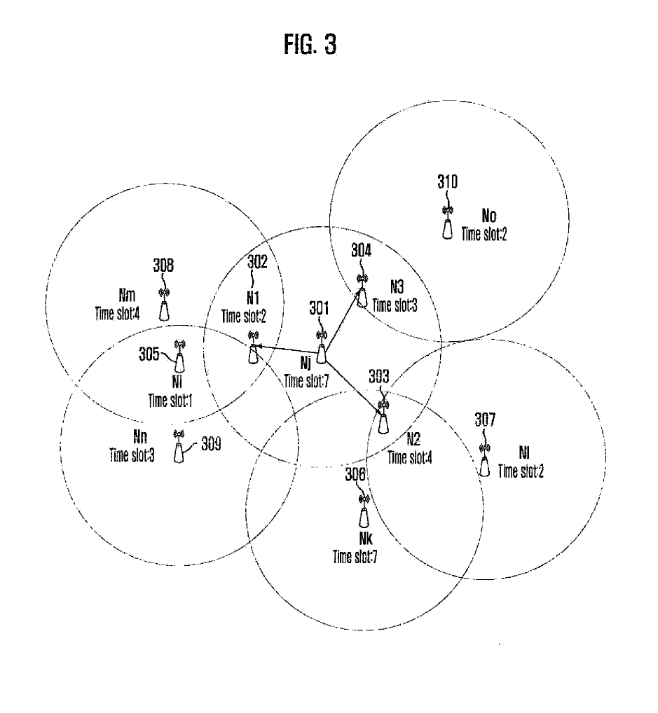

FIG. 3 is an explanatory view illustrating a beacon information collection procedure of avoiding indirect collision of beacon in a beacon-mode ad-hoc network in accordance with the present invention.

As shown in FIG. 3, a node Nj 301 collects beacon information from neighboring nodes (for example, nodes N1 302, N2 303, and N3 304) for a predetermined time period in an initial operation.

At this time, the node Nj 301 is assumed to be a Full Function Device (FFD).

For example, when the neighboring nodes (i.e., the nodes N1 302, N2 303, and N3 304) of the node Nj 301 are FFDs, they periodically transmit a beacon signal to the node Nj 301. Therefore, the node Nj 301 can collect beacon information of its neighboring nodes.

Meanwhile, when the neighboring nodes (i.e., the nodes N1 302, N2 303, and N3 304) are Reduced Function Devices (RFDs), they transmit no beacon signal to the node Nj 301. Therefore, in order to acquire the beacon information of the neighboring nodes (i.e., the nodes N1 302, N2 303, and N3 304), the node Nj 301 has to transmit a message requesting the time slot information (hereinafter, referred to as “time slot information request message”) to the neighboring nodes.

At this time, the RFD nodes (neighboring nodes) do not transmit a beacon signal in a beacon-mode ad-hoc network, but can receive RF signals during the beacon period of nodes connected to their own nodes for data communication. Accordingly, when the node Nj 301 transmits the time slot information request message to the nodes N1 302, N2 303, and N3 304, the nodes N1 302, N2 303, and N3 304 receive RF signals during the beacon period and at the same time collect the beacon information from the neighboring nodes, followed by transmitting the collected beacon information to the node Nj 301 together with their own beacon information.

Hereinafter, a procedure of collecting and managing beacon information of neighboring nodes by the nodes N1 302, N2 303, and N3 304 will be described in more detail.

FIG. 4 illustrates time slot information tables for beacon information management of neighboring nodes used in the present invention. That is, FIG. 4 describes a procedure in which the nodes N1 302, N2 303, and N3 304 shown in FIG. 3 collect and manage beacon information of their neighboring nodes.

In the beacon-mode ad-hoc network, the nodes N1 302, N2 303, and N3 304 manage beacon information of their neighboring nodes through the time slot information tables 410 to 430, as shown in FIG. 4.

The time slot information tables 410 to 430 include time slot number fields 411, 421 and 431 indicating time slot information, and use status fields 412, 422, 432 representing whether to use time slots, respectively.

When the node N1 302 receives a time slot information request message from the node Nj 301 of FIG. 3, it takes time slot information (i.e., time slot 1, time slot 4, and time slot 3) of its neighboring nodes Ni 305, Nm 308, Nn 309 and its own time slot information (i.e., time slot 2), and updates the time slot information table 410 based on the above information.

That is, since the time slots used by the node N1 302 itself and its own neighboring nodes are 1, 2, 3 and 4, the node N1 302 indicates “Yes” in the use status field 412 corresponding to the time slots 1, 2, 3, and 4 of the time slot information table 410 and indicates “No” in the use status field 412 corresponding to the remaining time slots.

At this time, the node N1 302 can acquire the time slot information of the nodes Ni 305, Nm 308, and Nn 309 in the same way as the node Nj 301 collects the time slot information of its neighboring nodes in FIG. 3 (see FIG. 3).

In addition, when the node N2 303 receives a time slot information request message from the node Nj 301 in FIG. 3, it collects time slot information (i.e., time slot 2 and time slot 7) of its neighboring nodes, i.e., N1 307 and Nk 306, and its own time slot information (i.e., time slot 4), and updates the time slot information table 420 based on the collected information.

That is to say, since the time slots used by the node N2 303 itself and its own neighboring nodes are 2, 4 and 7, the node N2 303 indicates “Yes” in the use status field 422 corresponding to the time slots 2, 4 and 7 of the time slot information table 420 and indicates “No” in the use status field 422 corresponding to the remaining time slots.

At this time, the node N2 303 can acquire the time slot information of the nodes NI 307 and Nk 306 in the same manner as the node Nj 301 collects the time slot information of the its neighboring nodes in FIG. 3 (see FIG. 3).

Further, when the node N3 304 receives a time slot information request message from the node Nj 301 in FIG. 3, it collects time slot information (i.e., time slot 2) of its neighboring nodes, i.e., No 310 and its own time slot information (i.e., time slot 3), and updates the time slot information table 430 based on the collected information.

That is, since the time slots used by the node N3 304 itself and its neighboring nodes are 2 and 3, the node N3 304 indicates “Yes” in the use status field 432 corresponding to the time slots 2 and 3 of the time slot information table 430 and indicates “No” in the use status field 432 corresponding to the remaining time slots.

At this time, the node N3 304 can acquire the time slot information of the node No 310 in the same manner as the node Nj 301 collects the time slot information of the neighboring nodes in FIG. 3 (see FIG. 3).

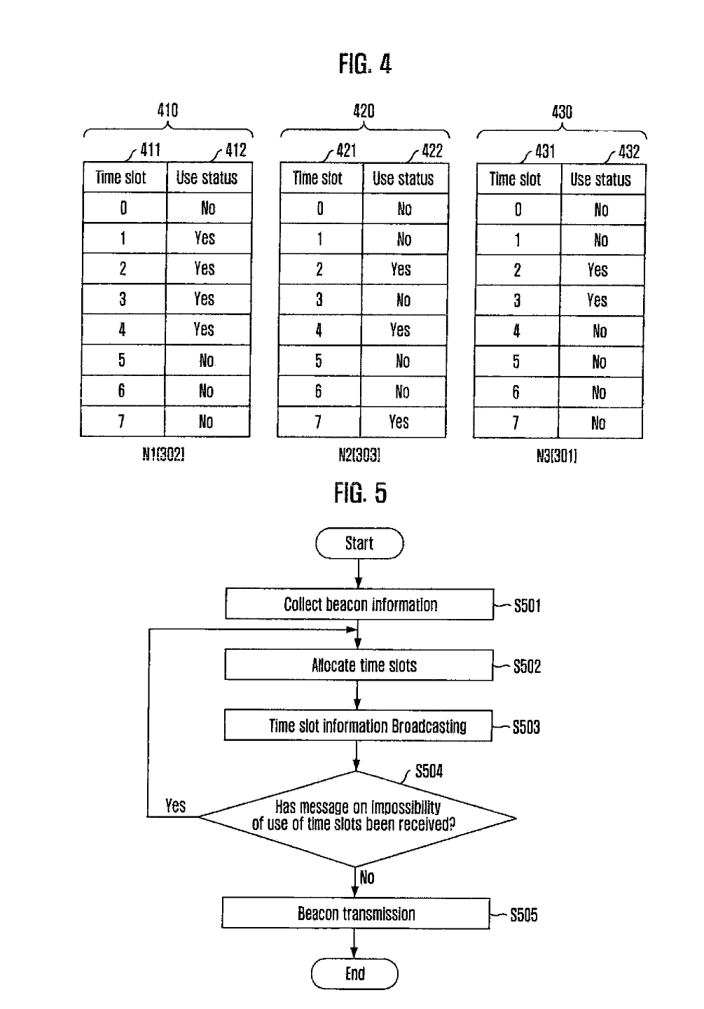

FIG. 5 is a flowchart illustrating a method for avoiding indirect collision of beacon by a node that newly allocates a time slot in a beacon-mode ad-hoc network in accordance with a preferred embodiment of the present invention.

First, a node that newly allocates a time slot (hereinafter, referred to as “new node”) collects beacon information of its neighboring nodes in the same manner as the node Nj 301 collects time slot information of its neighboring nodes in FIG. 3 in step S501.

At this time, the new node can know a beacon time point of neighboring nodes based on the collected beacon information of the neighboring nodes, and can also mange the beacon information of the neighboring nodes by using the corresponding time slot information table, as shown in FIG. 4.

Next, the new node allocates a time slot desired to be used according to a time slot allocation algorithm in step S502.

At this time, various conventional time slot allocation techniques may be used as the time slot allocation algorithm.

Thereafter, the new node broadcasts, to the neighboring nodes, information about the time slot (hereinafter, referred to as “time slot allocation message”) allocated to itself in step S502 at each beacon time point of the neighboring nodes in step S503.

Here, when the number of time slots is N, the new node broadcasts the time slot allocation message in synchronism with beacon time points (i.e., every time slot) of the neighboring nodes maximally (N−1) times.

In a next step S504, the new node checks whether information indicating that the time slot allocated to itself has been already used by the neighboring nodes (hereinafter, referred to as “time slot unavailability message”) has arrived for a ‘2*beacon period’.

As a result of checking in step S504, if the time slot unavailability message has not arrived for a ‘2*beacon period’, the new node determines that there is no time slot overlapping with the time slot allocated to itself in step S502, and transmits a beacon signal to its neighboring nodes by using the time slot allocated to itself in step S505.

Here, it is assumed that the neighboring nodes do not transmit a message indicating that there is no overlapping time slot (hereinafter, referred to as “time slot availability message”) to the new node in order to reduce unnecessary transmission in the network.

On the other hand, as a result of checking in step S504, if the time slot unavailability message has arrived for a ‘2*beacon period’, the new node determines that the time slot allocated to itself in step S502 overlaps with time slots being used by the neighboring nodes, and reallocates its desired time slot in step S502.

In this beacon-mode ad-hoc network, the node (new node) that newly allocates the time slot can avoid indirect collision of beacon by collecting the time slot information being used by its neighboring nodes and time slot information being used by further neighboring nodes of its neighboring nodes and expending a checking range of use of overlapping time slots.

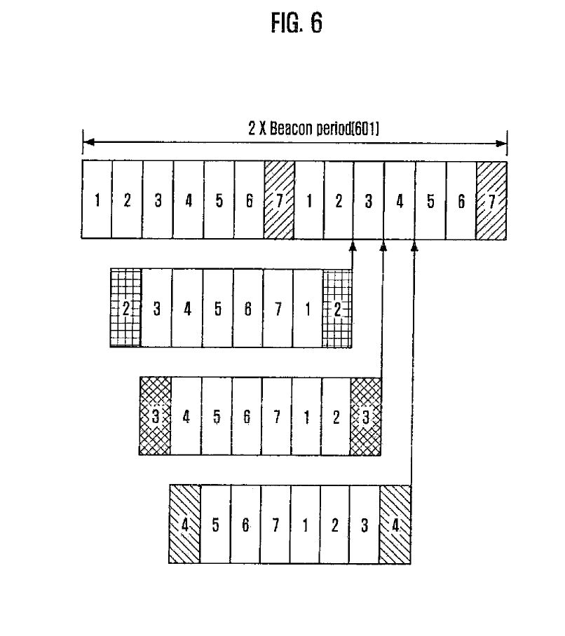

FIG. 6 is a view describing the time the node that newly allocates a time slot collects time slot information transmitted from neighboring nodes in a beacon-mode ad-hoc network in accordance with the present invention.

As shown in FIG. 6, the node (new node) that newly allocates a time slot allocates its desired time slot based on the time slot allocation algorithm, and broadcasts information on the allocated time slot (i.e., time slot allocation massage) to neighboring nodes.

At this time, the new node broadcasts the time slot allocation message including the information on the allocated time slot maximally 6 times every time slot. In other words, since the number of time slots is 7, the new node performs the broadcasting operation maximally 6 times, which subtracts one from the time slot number.

Next, the new node waits for a reply from the neighboring nodes for a ‘2*beacon period 601’.

Then, the neighboring nodes receiving the time slot allocation message from the new node collect time slot information from their neighboring nodes for their next beacon period, and check whether there is any slot overlapping with the time slot of the new node in the collected time slot information. If there is any slot overlapping with the time slot of the new node, the neighboring nodes transmit a time slot unavailability message to the new node during the next beacon period.

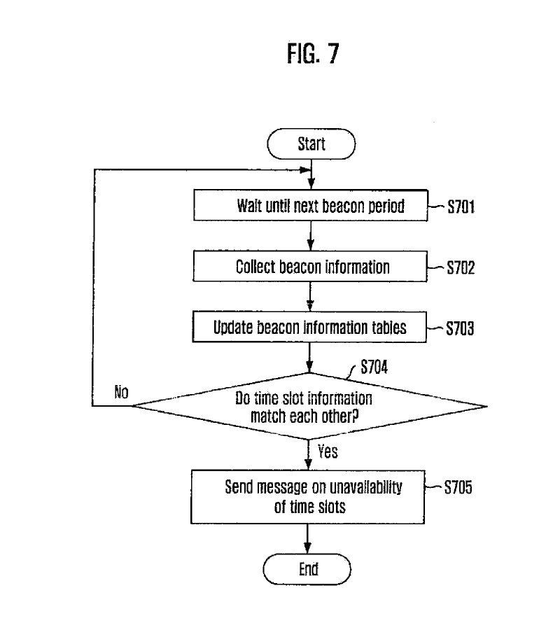

FIG. 7 is a flowchart describing a method for checking whether time slots of neighboring nodes receiving a time slot allocation message overlap in a beacon-mode ad-hoc network in accordance with the present invention.

When the neighboring nodes are FFDs, they transmit a beacon signal for each of their own beacon transmission periods and perform data communication. Therefore, they can receive a time slot allocation message from a node (new node) that newly allocation the time slot every time slot for their own beacon transmission. Meanwhile, when the neighboring nodes are RFDs, they perform data communication with their parent nodes every beacon transmission period of parent nodes connected to their own nodes, thereby receiving the time slot allocation message from the new node every time slot for beacon transmission of the parent nodes.

First, when the neighboring nodes receive the time slot allocation message from the new node, they wait until a next beacon transmission period (or a beacon transmission period of parent nodes) in order to collect their beacon information in step S701, set to receive an RF signal for the next beacon transmission period (or a beacon transmission period of the parent nodes), and collect beacon information from their neighboring nodes upon arrival of the next beacon transmission period (or a beacon transmission period of parent nodes) in step S702.

Next, the neighboring nodes update the corresponding beacon information tables based on the collected beacon information in step S703, and check whether the beacon time slot information of the updated beacon information tables match the time slot information of the time slot allocation message received from the new node in step S704.

At this time, the neighboring nodes can check whether the beacon time slot information matches the time slot information of the time slot allocation message received from the new node by using an overlapping flag value.

Here, if an overlapping flag value is ‘TRUE’, it is checked that the beacon time slot information matches the time slot information of the time slot allocation message received from the new node, and if an overlapping flag value is ‘FALSE’, it is checked that the beacon time slot information does not match the time slot information of the time slot allocation message received from the new node.

As a result of checking in step S704, if the beacon time slot information does not match the time slot information of the time slot allocation message received from the new node (i.e., if the overlapping flag value is ‘FALSE’), the neighboring nodes transmit no reply message and wait until a next beacon transmission period (or a beacon transmission period of parent nodes) in step S701.

Here, the neighboring nodes transmit no reply message (indicating that the beacon time slot information matches the time slot information of the time slot allocation message) in order to decrease unnecessary transmission.

On the other hand, as a result of checking in step S704, if the beacon time slot information matches the time slot information of the time slot allocation message received from the new node (i.e., if the overlapping flag value is ‘TRUE’), the neighboring nodes transmit a time slot unavailability message to the new node in step S705.

By the above-described procedure, indirect collision in the beacon-mode ad-hoc network can be almost avoided, but may occur due to any unexpected reason.

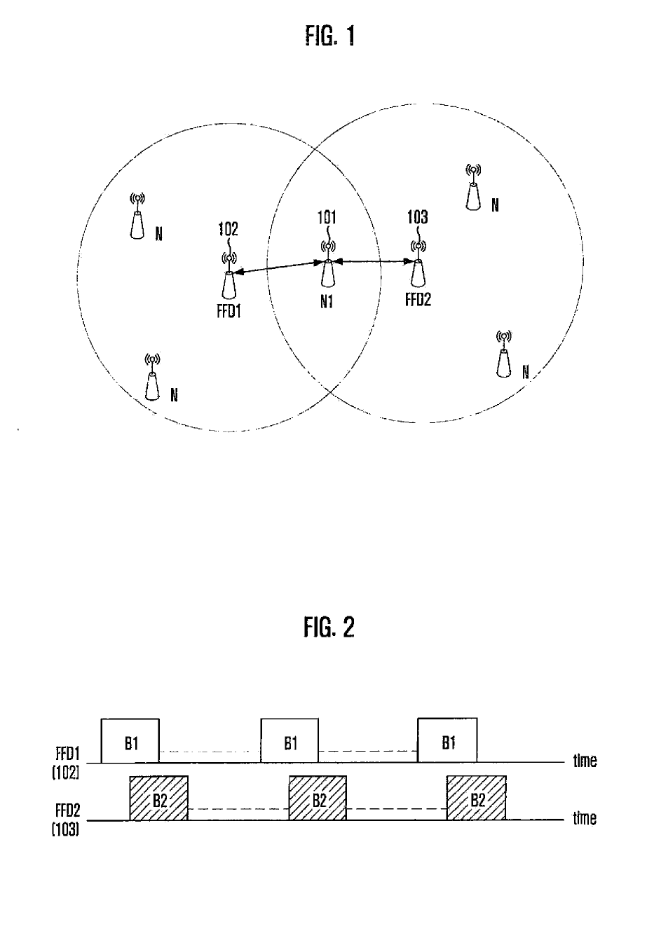

Now, a procedure of detecting indirect collision by a node in the beacon-mode ad-hoc network will be roughly described with reference to FIG. 1.

In FIG. 1, with the nodes FDD1 102 and FDD2 103 using the same time slot already operating, when the node N1 101 starts to operate, indirect collision occurs, thus causing an abnormal operation of the node N1 101.

At this time, when another FFD node (not shown) exists around the node N1 101, the node N1 101 connects to the corresponding FFD node, which enables a normal operation. However, when another FFD node does not exist around the node N1 101 and further connection is not allowed upon arrival of a maximal connection number, the node N1 101 fails to connect to neighboring nodes, which does not make a normal operation.

Therefore, when searching neighboring nodes, the node N1 101 first searches their energy before performing searching for signals. At this time, when very high energy is detected upon searching of energy but beacon signal is not found upon its searching, it is predicted that indirect collision has occurred at neighboring nodes.

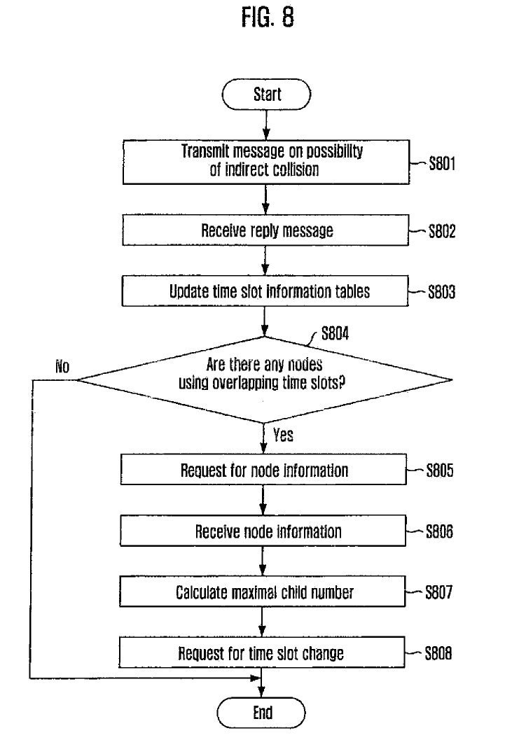

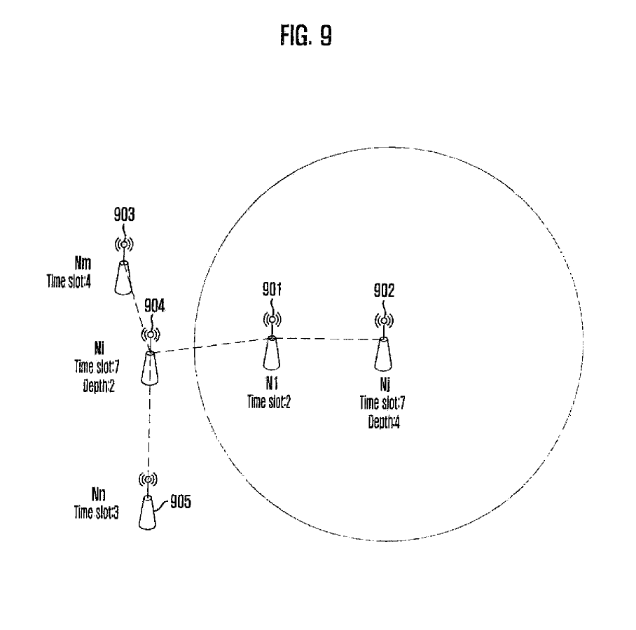

FIG. 8 illustrates a flowchart of a method for requesting neighboring nodes to change collided time slots when indirect collision of beacon occurs in a beacon-mode ad-hoc network in accordance with the present invention. This will be described in more detail with reference to FIG. 1.

First, when the node N1 101 predicts that indirect collision has occurred at neighboring nodes, it transmits a message notifying possibility of indirect collision (hereinafter, “indirect collision possibility message”) to the neighboring nodes at random intervals in step S801.

At this time, when the neighboring nodes receive the indirect collision possibility message, they transmit a reply message to the indirect collision possibility message to the node N1 101. Here, the reply message to the indirect collision possibility message contains address values of the neighboring nodes and time slot information.

Next, the node N1 101 receives the reply message to the indirect collision possibility message from the neighboring nodes in step S802, and updates the corresponding time slot table based on the received reply message in step S803.

Thereafter, the node N1 101 checks whether there is any node using overlapping time slots among the neighboring nodes on the basis of the updated time slot table in step S804.

As a result of checking in step S804, if there is no node using overlapping time slots among the neighboring nodes, the node N1 101 performs data communication without any change request for time slots of the neighboring nodes. And, if there is any node using overlapping time slots among the neighboring nodes, the node N1 101 request the nodes using the overlapping time slots to offer information (node information) about the depth of nodes and the number of child nodes (the number of routers and end nodes) in step S805.

At this time, the nodes receiving the request for the node information from the node N1 101 transmit their own node information to the node N1 101. Here, the node information contains the information about the depth of nodes and the number of child nodes (the number of routers and end nodes) after random delay time.

Subsequently, the node N1 101 receives node information from nodes using the overlapping time slots in step S806, and calculates the possible maximal number Cmax of children at the current state of each node based on the received node information by using the following equation:

Cmax=n*CSkip(k−1)+m Eq. (1)

Wherein k denotes the depth of node, m denotes the number of routers, and n denotes; the number of end nodes.

Thereafter, the node N1 101 requests a node having the smallest Cmax value to change the time slot in step S808.

FIG. 9 is an explanatory view describing an overhead with respect to the depth of node in a beacon-mode ad-hoc network in accordance with the present invention.

As shown in FIG. 9, in the beacon mode ad-hoc network, when a node N1 901 requests a node Ni 904 to change a time slot, it is required to change time slots of its child nodes (node Nm 903 and node Nn 905) as well as the node Ni 904. Therefore, more overhead is generated as compared to the case where the node N1 901 requests the node Ni 904 to change a time slot. Accordingly, when the indirect collision has occurred in the beacon mode ad-hoc network, the node N1 901 requests a node with the largest depth to change a time slot.

However, when the node NI 901 finds its neighboring FFD node (not shown) and connects to it during the request for time slot change to the node N±904 or node Nj 902, it initializes the corresponding time slot table and finishes the transmission of indirect collision possibility message to the node Ni 904 and node Nj 902.

As described above, the present invention can operate a network more stably by avoiding indirect collision between nodes in a beacon-mode ad-hoc network.

In addition, the present invention can solve indirect collision more efficiently, by changing a time slot of a node having the largest depth, when the indirect collision has occurred in a beacon-mode ad-hoc network.

The method of the present invention as mentioned above may be implemented by a software program that is stored in a computer-readable storage medium such as CD-ROM, RAM, ROM, floppy disk, hard disk, optical magnetic disk, and the like. This process may be readily carried out by those skilled in the art; and therefore, details of thereof are omitted here.

While the present invention has been described with respect to the particular embodiments, it will be apparent to those skilled in the art that various changes and modifications may be made without departing from the spirit and scope of the invention as defined in the following claims.

What is claimed is:

1. A method for avoiding indirect collision of beacon, comprising:
collecting beacon information of neighboring nodes and allocating a time slot based on the collected beacon information;
transmitting information on the allocated time slot to the neighboring nodes depending on time slots of the neighboring nodes; and
checking whether the time slot overlaps based on a reply message from the neighboring nodes and reallocating a time slot upon occurrence of overlapping.

2. The method of claim 1, wherein the time slot reallocating includes:
checking the time slot overlaps on the basis of a reply message to the time slot information transmitted from the neighboring nodes;
if it is checked that the time slot does not overlap, transmitting a beacon signal to the neighboring nodes by using the allocated time slot; and
if it is checked that the time slot overlaps, reallocating a time slot.

3. The method of claim 2, wherein in the time slot overlap checking, the time slot is checked to be overlapped for a time twice the beacon period.

4. The method of claim 1, wherein the information transmitting repeatedly transmits the information on the allocated time slot based on the time point of beacon occurrence of the neighboring nodes the number of times less than the number of time slots by 1.

5. The method of claim 4, wherein, when the neighboring nodes are Full Function Devices (FFDs), a sensor node periodically receives the beacon information from the neighboring nodes.

6. The method of claim 4, wherein, when the neighboring nodes are Reduced Function Devices (RFDs), a sensor node requests the neighboring nodes to send time slot information of the neighboring nodes and receives the beacon information from the neighboring nodes.

7. A method for overcoming beacon collision, comprising:
upon prediction of indirect collision occurrence at neighboring nodes, transmitting an indirect collision possibility message to the neighboring nodes and receiving a reply message from the neighboring nodes;
upon presence of overlapping time slot based on the received replay message, requesting neighboring nodes which use the overlapping time slot to send node information and receiving the node information; and
requesting for the time slot change based on the received node information.

8. The method of claim 7, wherein the time slot change requesting includes:
calculating the maximal number of children of each of the neighboring nodes based on the received node information; and
requesting a node having the smallest number (the deepest node) among the calculated maximal number of children to change the time slot.

9. The method of claim 8, wherein the node information contains information about the depth of node and the number of child nodes (the number of routers and the number of end nodes).

10. The method of claim 9, wherein the maxial number of children calculating calculates the maximal number of children of each of the neighboring nodes on the basis of the depth of node and the number of child nodes received (the number of routers and the number of end nodes) by using the following equation:
Cmax=n*CSkip(k−1)+m
wherein k denotes the depth of node, m denotes the number of routers, and n denotes the number of end nodes.

11. The method of claim 7, wherein, in the indirect collision possibility message transmitting, it is predicted that when a high energy of the neighboring nodes is detected but a beacon signal is not found upon searching of the beacon signal, the indirect collision has occurred at the neighboring nodes.
